(19) United States
(12) Patent Application Publication
(10) Pub. No.: US 2005/0237864 A1
(43) Pub. Date: Oct. 27, 2005

(54) Device for adjusting the length of a band, in particular of a watch band

(75) Inventor: Carlo Albisetti, Courtelary (CH)

Correspondence Address: SUGHRUE MION, PLLC, 2100 PENNSYLVANIA AVENUE, N.W., SUITE 800, WASHINGTON, DC, 20037, US

(73) Assignee: THE SWATCH GROUP MANAGEMENT SERVICES AG

(21) Appl. No.: 11/109,708

(22) Filed: Apr. 20, 2005

(30) Foreign Application Priority Data
Apr. 23, 2004 (EP) 04009671.1

(51) Int. Cl. G04B 37/00

(52) U.S. Cl. 368/282

(57) ABSTRACT

The present invention concerns a device for adjusting the length of a band, this band comprising two parts (1 and 2) able to be moved closer to or away from each other, characterised in that it includes an assembly (4, 5, 3) for adjusting the length of the band, carried by the first part (1) and including at least one cable (3), said cable (3) connecting the first part (1) to the second (2), said adjustment assembly (4, 5, 3) including means for actuating (4) the adjustment by the user, an adjustment pulley (5) secured to said means (4) to which one of the ends of the cable (3) is secured and around which a part of the cable (3) is wound, said pulley being associated with locking means (6, 7, 9) capable of blocking the pulley in rotation in a plurality of adjustment positions. Applications for any fastening system. A preferential application would be for adjusting the length of watchbands.

This application claims priority from European Patent Application No. 04009671.1 filed Apr. 23, 2004, the entire disclosure of which is incorporated herein by reference.

The present invention concerns a device for adjusting the length of a band, particularly but not exclusively, a watchband for lengthening or shortening the latter in accordance with the wishes of the user.

For example, for a watchband, when climatic conditions vary the parameters of the wrist, particularly in the summer when the latter tends to swell up, it is often necessary to lengthen the wristband for the sake of comfort.

If a watch with multiple functions is used, for example a heart rate monitor that uses sensors placed in the back cover of the watchcase and has to come into close contact with the user's wrist, proper tightening has to be guaranteed when the measurement is taken, such tightening having to be maintained during the entire heart rate monitoring operation. In fact, as such apparatus generally perform various operations such as mean measurements from pulse values measured during a given time, one has to ensure that there is no interruption to the measurement falsifying the mean so that the value displayed is properly representative of the effort provided during said given time.

The tightening of the wristband on the user's wrist must thus be able to be adjusted precisely for the watch to be in proper pulse measuring conditions and maintained in these adjusting conditions even in difficult working conditions, such as during running during which the wristband is subject to significant shocks and vibrations. During these efforts, as the wrist tends to swell up, the user has to be able to reduce the tightening of the wristband without losing the measurement.

Likewise, during normal use of the watch, marked tightening on the user's wrist like when measurements are taken is no longer necessary and is even undesirable for reasons of convenience: there thus exists a need to be able to alter the tightening conditions of the wristband in accordance with the use of the heart rate monitor or similar watch, such alteration having to occur as easily as possible, particularly without needing to remove the watch from the wrist.

To date, no satisfactory technical solution to these difficulties has been proposed.

CH Patent No. A-665327 discloses a device for attaching a wristband to a watchcase for winding the wristband around a pillar and thus reducing or extending the size of the wristband. This document does not show any mechanism locking the winding or unwinding of the wristband, but only one or more bosses creating an obstacle preventing the pillar from coming out of the link. This device does not allow precise adjustment of the size of the wristband, nor does it maintain such adjustment during use and thus it is not suitable for the uses set out hereinbefore.

DE 20020360 U discloses a device for adjusting the length of a watchband. The two ends of the watchband are secured to a winding shaft, housed in a case in two parts, the shaft being able to rotate owing to a knurling roller, to be fixed in its position and released owing to an uncoupling mechanism. In order to do this, the winding shaft comprises a disc which has at its upper surface a notching which cooperates with a corresponding notching on a disc fixed to and underneath the knurling roller, this latter disc being surrounded by a toothed crown provided with an external toothing in which a locking click, secured to the case, is inserted. Means for centering the device and means for returning the device to the notched position are also provided.

This device with its numerous mechanical parts is complicated, expensive and, given the large number of parts involved, liable to be put out of order. Moreover, this device does not guarantee controlled unwinding of the watchband but only release of the winding shaft, which can allow the watchband to be unwound. Further, this device acts directly on the watchband by winding it around the winding shaft. The device is thus limited to certain types of watchbands, i.e. watchbands that can easily be wound, and has the drawback of damaging the watchband by its direct action thereon.

The problem at the basis of the present invention is thus to be able to carry out a two-directional adjustment of the length of a band quickly and precisely, such adjustment having to be maintained in all conditions of use.

In order to resolve this problem, the present invention proposes a device for adjusting the length of a band, this band including two parts able to be moved towards or away from each other, characterized in that it comprises a band length adjustment assembly, carried by the first part and comprising at least one cable, this cable connecting the first part to the second, this adjustment assembly comprising means for actuating the adjustment by the operator, an adjustment pulley secured to such means to which one of the ends of the cable is fixed and around which a part of the cable is wound, this pulley being associated with locking means capable of locking it in rotation in a plurality of adjustment positions.

The actuation means can be a knurling roller, mobile axially on the one hand between a locking position and an adjustment position, the knurling roller being pushed into its locking position by elastic means, and on the other hand, mobile in rotation to carry out adjustment of the band length.

The adjusting pulley is housed inside a hollow body secured to the part and comprises wings, said wings cooperating with locking means provided on the body, which includes, on its upper part, notches adapted for receiving the latter in order to block the rotation of the adjusting pulley. This body can be formed of two parts irremovably fixed to each other.

The other end of the cable is fixed to the first part of the band and a portion of the intermediate zone of the cable is received in the second part so as to be able to slide therein.

Advantageously, an additional return pulley can be provided on the second part of the band for redirecting the cable towards the first part.

The present invention also concerns a watchband with one of the length adjustment devices described hereinbefore.

Other features and advantages of the present invention will appear from the following description, made with reference to the drawings and giving by way of non-limiting example an advantageous embodiment of the band length adjustment device and in which:

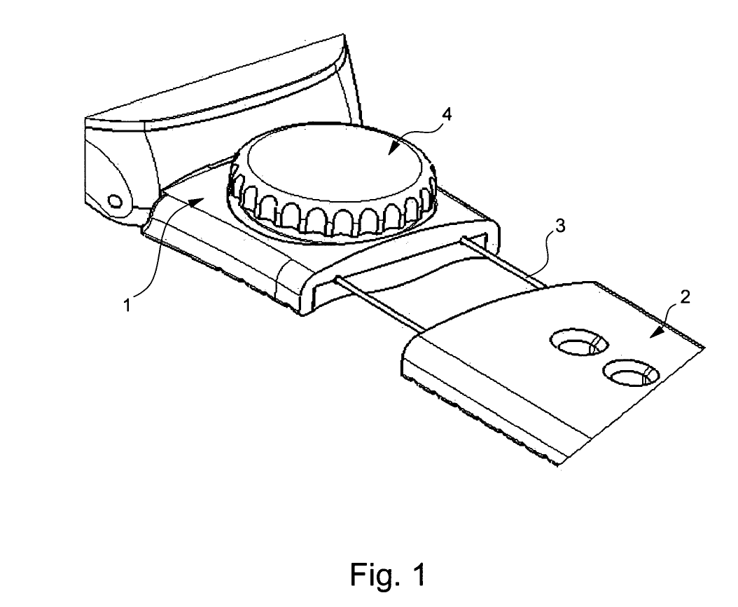

FIG. 1 shows a perspective top view of the two parts of the band with the adjustment knurling roller on one of the parts.

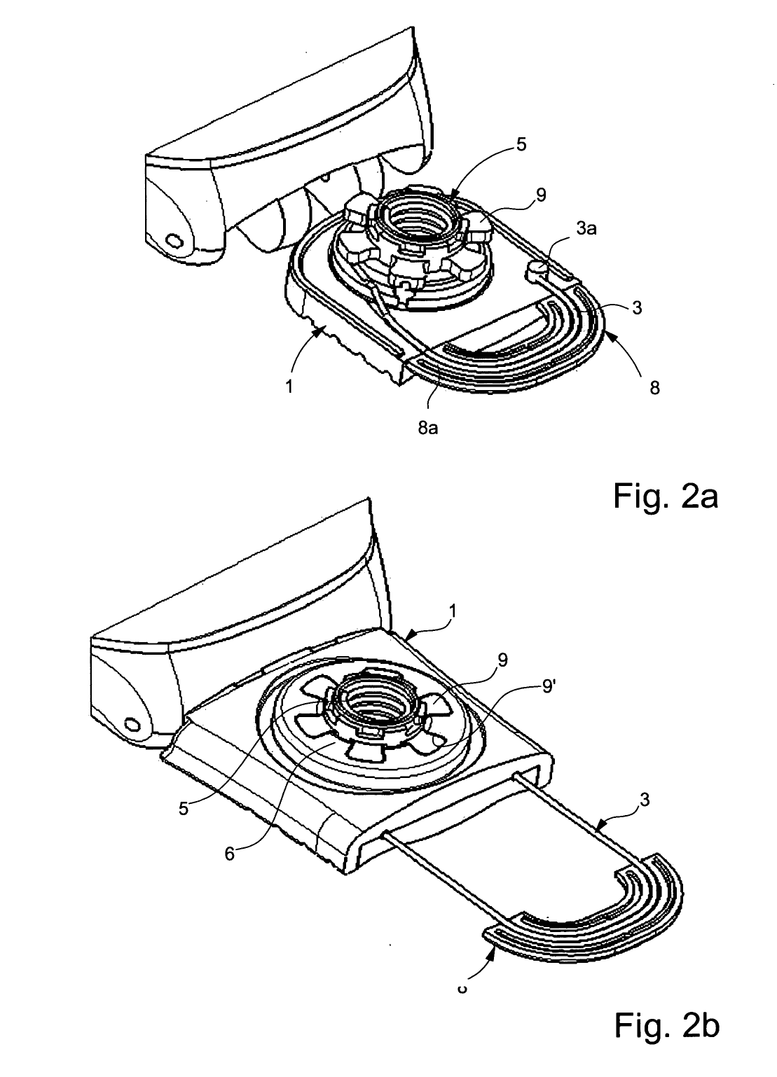

FIGS. 2a and 2b show a perspective top view of the band length adjustment system according to an embodiment of the invention with a pulley in the form of a body with wings respectively in the taut adjustment position and in the relaxed adjustment position,

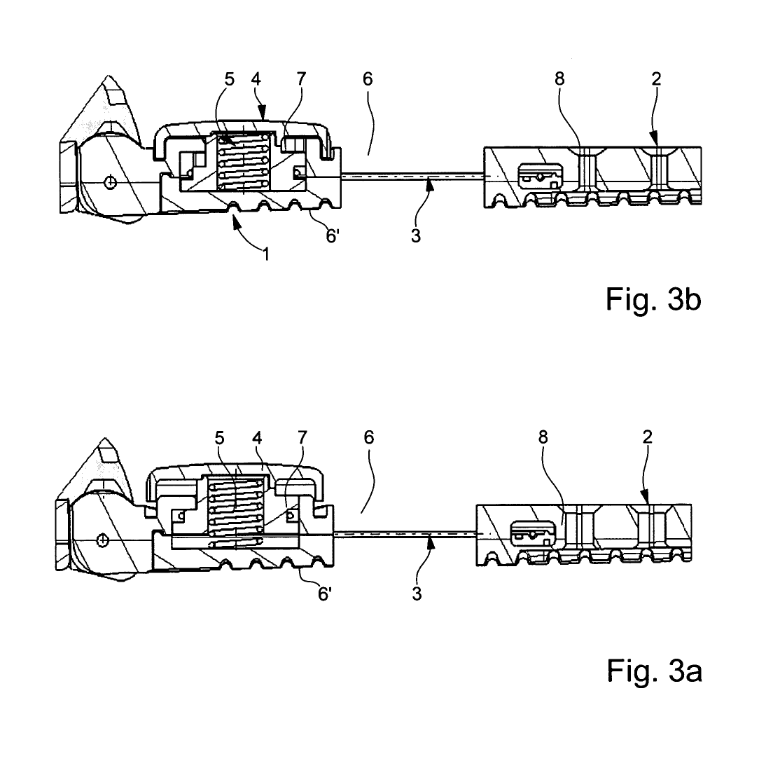

FIGS. 3a and 3b show a cross-section of the two parts of the band their device for adjusting the length of the band with the pulley respectively in its high and low positions.

In FIG. 1, two parts 1 and 2 of a band can be seen, forming a watchband in this example, these two parts being connected to each other by a cable 3 which enables them to be moved apart or closer together and thus the useful length of the watchband to be adjusted in accordance with the user's requirements. This watchband length adjustment is carried out manually by the user by pressing and rotating a knurling roller 4 forming the actuating means and located on the upper part of the adjustment assembly comprising knurling roller 4, a pulley 5, and cable 3 which will be described in detail hereinafter.

As is clear from FIGS. 2a, 2b, 3a and 3b, cable 3 has one of its ends fixed to part 1 at 3a and the other in adjustment assembly 4, 5, 3 on the drum of pulley 5 in the example shown. From each of these two ends, cable 3 extends towards the part 2 with two substantially parallel arms that end in a U or V shape at the place where the cable passes through part 2. Advantageously, part 2 is provided with an insert 8 comprising a channel 8a for receiving cable 3. The surface of the channel in which the cable slides preferably has a low friction coefficient to facilitate the movement of the cable therein. This surface can be, for example, coated with a Teflon layer. Likewise, cable 3 can also be coated with a layer of this type. According to a variant that is not shown, additional guide means can be provided for the cable in the insert, these guide means being able to take the form of a return pulley disposed at the base of the U or V of the insert.

FIGS. 2a and 2b respectively show a taut adjustment position and one of the relaxed adjustment positions possible obtained by adjustment assembly 4, 5, 3. In these Figures, knurling roller 4 has not been shown in order to allow the rest of the adjustment assembly to be seen and particularly the cooperation between adjustment pulley 5 and cable 3.

In FIG. 2a, it can be seen that the adjustment assembly comprises an adjustment pulley 5 around which cable 3 is wound. This Figure illustrates the maximum winding position of the cable and thus the maximum shortening of the watchband with parts 1 and 2 of the watchband joined.

In the case of FIG. 2b, adjustment pulley 5 has undergone a rotation in the anticlockwise direction and has unwound a portion of cable thus moving parts 1 and 2 apart and thereby lengthening the watchband. The watchband is then in a relaxed adjustment position. There therefore exist several relaxed adjustment positions, these positions corresponding to more or less pronounced unwinding of cable 3 of adjustment pulley 5. Cable 3 has thus slid into the channel of insert 8 of part of the watchband, hence the necessity of using an insert 8 and a cable 3 with the lowest possible friction coefficient.

In the embodiments of FIGS. 2a and 2b, pulley 5 comprises at its periphery wings 9 which cooperate with notches 9′ of the same shape arranged on the upper part 6 of a body 6 and 6′ comprised in part 1 of the watchband to allow wings 9 to be inserted in upper part 6 and thus to block adjustment pulley 5 in an adjustment position as will be described in detail hereinafter. Additionally, these wings 9 can advantageously form a guide flange for cable 3 when it is wound and hold it around adjustment pulley 5.

FIGS. 3a and 3b describe the operation of the adjustment assembly according to the invention in the embodiment with an adjustment pulley 5 with wings and a body with its upper part 6 having notches 9′ for locking the adjustment assembly. As already explained in FIGS. 2a and 2b, knurling roller 4 and adjustment pulley 5 are secured to each other and in their adjustment position can carry out a rotation to wind or unwind cable 3 thus adjusting the length of the watchband; moreover knurling roller 4 and adjustment pulley 5 are mobile axially between a position in which knurling roller 4 in is the high position called the rest or locking position and a position where knurling roller 4 is in a low position called the adjustment position. The assembly of knurling roller 4 and adjustment pulley 5 is return by elastic means, here a helical spring 7 extending between the lower surface of knurling roller 4 and the lower part 6′ of body 1, in its rest position. This assembly is partially housed in a body with upper parts 6 and lower parts 6′ secured to part 1 of the watchband, a space being arranged between the base of lower part 6′ of the body and the lower part of adjustment pulley 5 to allow the latter to move axially in the body.

In FIG. 3a, when knurling roller 4 is in the high position, wings 9 of adjustment pulley 5 are housed in notches of corresponding shape of upper part 6 of the body secured to part 1: adjustment pulley 5 is thus blocked in rotation and cable 3 cannot be wound or unwound.

In FIG. 3b, in order to carry out the adjustment of the length of the bracelet, the wearer presses onto knurling roller 4 which pushes adjustment pulley 5 into the body and releases the wings from the notches provided on the upper part 6 of the body.

The knurling roller—pulley assembly is thus free in rotation and the cable can be adjusted. Adjustment pulley 5 can thus be rotated to a position where wings 9 are again in correspondence with the notches of upper part 6 of the body: at that moment the user can release the pressure on knurling roller 4, elastic means 7 will return the knurling roller—pulley assembly to its rest position, i.e. with knurling roller 4 in the high position and wings 9 of adjustment pulley 5 again housed in the notches of upper part 6 of the body: the watchband length adjustment system will again be blocked.

Advantageously, knurling roller 4 can be made of a transparent material to allow the user to align wings 9 of adjustment pulley 5 easily with the corresponding notches of upper part 6 of the body. This easy alignment can be achieved with markings printed or in relief arranged on knurling roller 4 and on the upper part 6 of the body.

The adjustment device shown in the annexed Figures represents a first embodiment of the invention.

Other embodiments of the locking mechanism with blocking means other than notches are also possible.

In a second embodiment, the adjustment pulley comprises on one of its upper or lower faces concentric recesses for receiving a finger projecting from the first part of the watchband, this finger being introduced into one of the concentric recesses when the elastic means return the actuating means—adjustment pulley assembly to its locking position.

As regards the embodiment described, variants of the various components of the locking assembly can be achieved. Thus, spring 7 can be replaced by a strip spring disposed at the bottom of the housing of lower part 6′ of the body for receiving adjustment pulley 5, this spring returning adjustment pulley 5 upwards.

Moreover, the notches have been shown on upper part 6 of the body but can be placed at other levels. It is even possible to provide a low rest position for knurling roller 4 with an adjustment position where the knurling roller is high, by reversing the effect of the return means.

As was seen in light of the present description, the device of the present invention allows the band to be adjusted precisely and securely in a simple manner.

Within the field of horology, it will be observed that such a device answers the requirement for quick, reliable tightening and that its application to heart rate monitors provides a decisive advantage. It can also provide an alternative to the conventional means for fastening a watchband.

Likewise, this device can find application in a metal wristband where it is preferable not to remove or add links. In this case, parts 1 and 2 of the band could form two particular links inserted in the chain of links, these two parts comprising, for this purpose, means for connecting to the rest of the chain of links. Alternatively, the cable could for example pass through several links to distribute the spacing with the first part between several links. For example, if the wristband is formed by two wires, preferably elastic wires, successively fitted onto the links, these two wires can be replaced by the cable associated with the adjustment assembly according to the present invention. Adjustment could be distributed over the set of links reducing the play between each of them which would not detract from the aesthetic appearance.

1. A device for adjusting the length of a band, this band comprising two parts able to be moved closer to or away from each other, wherein it includes an assembly for adjusting the length of the band, carried by the first part and including at least one cable, said cable connecting the first part to the second, said adjustment assembly including means for actuating the adjustment by the user, an adjustment pulley secured to said means to which one of the ends of the cable is secured and around which a part of the cable is wound, said pulley being associated with locking means capable of blocking the pulley in rotation in a plurality of adjustment positions.

2. The adjustment device according to claim 1, wherein the actuating means include a knurling roller mobile axially between a locking position and an adjustment position, said knurling roller being mobile in rotation in said adjustment position.

3. The adjustment device according to claim 2, wherein the adjustment pulley is housed inside a hollow body secured to the first part, in that said pulley includes wings provided for cooperating with said wings to block in rotation said pulley in the locking position.

4. The adjustment device according to claim 3, further including return means for returning said knurling roller to the locking position.

5. The adjustment device according to claim 3, wherein the body is formed of two parts irremovably fixed to each other.

6. The adjustment device according to claim 1, wherein the other end of the cable is fixed to the first part of the band and wherein one portion of an intermediate zone of the cable is received in the second part so as to be able to slide therein.

7. The adjustment device according to claim 6, wherein the second part of the band includes guide means for the cable, having a channel for receiving the cable, the inner surface of the channel having a low friction coefficient.

8. The adjustment device according to claim 6, wherein at least one additional return pulley is provided on the second part of the band for redirecting the cable towards the first part.

9. A watchband including a length adjustment device according to claim 1.
